(19) United States
(12) Patent Application Publication
(10) Pub. No.: US 2011/0260446 A1
(43) Pub. Date: Oct. 27, 2011

(54) MULTIPLE PORT PARALLEL ACCESS PIPING FLANGE

(75) Inventors: Alex V. Degutis, La Grange Park, IL (US); Raymond P. Bass, Beaumont, TX (US); Peter J. Gubricky, Crest Hill, IL (US); William R. Borowski, Palos Park, IL (US); Andrew J. Borowski, Palos Park, IL (US)

(73) Assignee: Salco Products, Inc., Lemont, IL (US)

(21) Appl. No.: 12/816,658

(22) Filed: Jun. 16, 2010

Related U.S. Application Data
(60) Provisional application No. 61/327,451, filed on Apr. 23, 2010.

(51) Int. Cl. F16L 41/00

(52) U.S. Cl. 285/122.1

(57) ABSTRACT

A multiple port, parallel access, piping flange has a body with a forward face, a rear face and a throughbore. A plurality of extension segments include a partial bore extending from the forward face, and a radial bore in fluid communication with the partial bore, at least some of which are in communication with the throughbore. In one form, the piping flange includes a tube secured in the throughbore having holes in communication with the radial bores in some extension segments. A separate partial bore extends through the rear face of the body and communicates with at least one radial bore in at least one extension segment. A metal segmented ring is employed to support connection elements.

### CROSS-REFERENCE TO RELATED APPLICATIONS

This patent application claims the benefit of U.S. Provisional Patent Application No. 61/327,451, filed Apr. 23, 2010, which is incorporated by reference.

### BACKGROUND OF THE INVENTION

This disclosure is related to piping components for fluid handling systems that provide access to the fluid system. More particularly, it relates to such components that provide multiple access and multiple discharge capability.

Handling of liquids in various disciplines such as chemical or petroleum processing involves storage, shipment and transfer of material highly corrosive, or otherwise deleterious, to containment equipment made of metal. Accordingly, it is necessary to isolate the contact surfaces of the equipment from the liquid.

In the past, containment vessels, as well as flow components such as metal tubes, elbows, tees, or the like, have been lined with rubber to isolate the contact surfaces from the corrosive liquid. More recently, plastic lines or plastic components have been employed to reduce the cost. Tubes, elbows, tees, and the like, have been made of PVC or other plastics. These components are relatively effective, but lack durability under the arduous conditions experienced, for example, in transporting the corrosive liquid by rail, or tractor trailer truck.

Most recently, piping components have been successfully made from ultra high molecular weight polyethylene (UHMWPE). These components possess the requisite resistance to the liquids being handled and the necessary durability to make their use cost effective.

In typical piping systems, it is advantageous to provide access to the fluid flow path for example to connect instrumentation, add system fluid, draw fluid samples, introduce air or perform other activity within the fluid handling process. Such a device, known as a parallel instrument tee, is available from Salco Products, Inc., Lemont, Ill. It is a planar flange installed between adjacent pipe flanges. It includes a main passage that defines a continuation of the system flow path between the connected pipes. It includes a lateral, or side extension, defining an access port connectable to an ancillary system element such as a gauge, or a fluid supply. A lateral passage communicates between the main system flow path and the connectable port.

This arrangement provides an additional advantageous feature in that the attached component resides on a longitudinal axis parallel to the longitudinal extent of the main piping system rather than perpendicular to it as with conventional piping tees.

### SUMMARY OF DISCLOSURE

It has been determined that significant enhancement to overall usefulness of such devices can be achieved by the provision of multiple access ports. Even further versatility derives from the provision of separated outlets from the access ports, all within the associated fluid system.

### BRIEF DESCRIPTION OF THE DRAWINGS

FIG. 1 is a perspective view of an exemplary piping system incorporating a parallel instrument tee.

FIG. 2 is a plan view of the parallel instrument tee of the piping system of FIG. 1.

FIG. 3 is a cross-sectional side view of the parallel instrument tee of FIG. 2 taken along the line 3-3 of FIG. 2.

FIG. 4 is a plan view of a multiple part parallel access piping flange illustrative of the present disclosure.

FIG. 5 is a side view in cross-section of the multiple port parallel access piping flange of FIG. 4.

FIG. 6 is a perspective view of a cap useful in connection with the piping flange of FIGS. 4 and 5.

FIG. 7 is a perspective view of another embodiment of a multiple port parallel access piping flange of the present disclosure.

FIG. 8 is a top view of the multiple port parallel access piping flange of FIG. 7.

FIG. 9 is a sectional view of the multiple port, parallel access, piping flange of FIGS. 7 and 8 taken along the line 9-9 of FIG. 8 installed onto an exemplary containment vessel and illustrating various features of the present disclosure.

FIG. 10 is a top plan view of a portion of the multiple port parallel access piping flange of FIGS. 7 to 9.

### DETAILED DESCRIPTION OF THE ILLUSTRATED EMBODIMENTS

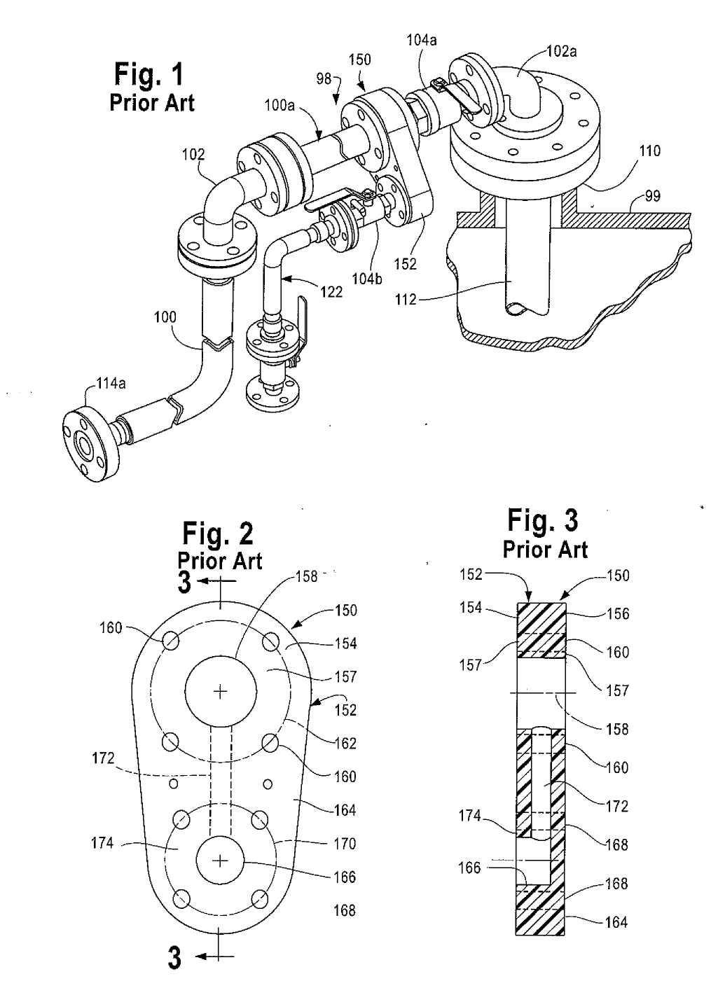

FIG. 1 shows a representative fluid piping system generally designated 98 associated with a vehicular tank car or railroad tank car. Such cars include a containment vessel 99 to transport lading such as liquid chemicals or petroleum products.

The illustrated piping system includes a series of flanged pipes 100, flanged elbows 102, and flanged valves 104, bolted together in fluid tight relation to form a closed fluid flow path or system. Flanged elbow 102a connects to a tank flange 110 of the containment vessel 99. It supports a flanged tube 112 that extends into the containment vessel. Flanged connector 114a is adapted for connection to associated equipment (not shown) for supplying fluid to, or receiving fluid from, the containment vessel. Tube 112 may be of any length and may extend to near the bottom of the vessel. This system is, of course, illustrative only and not intended to limit the applicability of the subject matter disclosed and claimed herein.

In this illustration, a single port parallel instrument tee 150 is connected to the fluid system between valve 104a and flanged pipe 100a. It is also connected in fluid tight relation to an associated flanged valve 104b which forms an element of an ancillary fluid piping system 122. This ancillary path may comprise a sampling port, a fluid path for addition, or removal, of fluid, or a measurement gauge attachment port.

The single port parallel instrument tee 150 is illustrated in FIGS. 2 and 3. It is preferably made of UHMWPE. However, metal, lined with non-corrosive polymer is also contemplated. The single port parallel instrument tee 150 includes a solid planar body 152 having a forward face 154 and a rear face 156. It includes a cylindrical throughbore 158 formed on a diameter to match the interior bore of associated piping. Throughbore 158 defines the main flow passage of the fluid system through the parallel instrument tee 150.

A pattern of bolt holes 160 extending through body 152 surround flow passage 158, equally spaced about a bolt circle diameter 162. The number of holes 160 and the size of the bolt circle diameter match the bolt hole pattern of attachment flanges on the associated flanged pipes 100, flanged elbows 102, and flanged valves 104 which connect the piping system to the parallel instrument tee 150. Forward face 154 and rear face 156 define gasket surfaces 157 surrounding throughbore 158 to ensure a fluid tight connection to the associated system piping.

As best seen in FIGS. 2 and 3, the single port parallel instrument tee 150 includes a lateral extension portion 164. The extension 164, has a fluid system access port in the form of a cylindrical partial bore 166 extending from forward face 154 partially toward rear face 156. It is formed on an axis parallel to the axis of the cylindrical throughbore 158.

Partial bore 166 is surrounded by a pattern of bolt holes 168 extending through body 152 on a bolt circle diameter 170 arranged to receive and connect to flanged valve 104b of ancillary fluid piping system 122 or any other component for which connection to the main flow path of the piping system is desired. With this orientation, ancillary piping system 122 and the main piping system are parallel to each other.

The forward face 154 defines a gasket surface 174 surrounding partial bore 166. Flanged valve 104b is bolted onto forward face 154 in fluid tight relation.

Throughbore or flow passage 158 and partial bore or passage 166 are connected in fluid communication by radial fluid passage 172. This passage provides a fluid communication path between the main fluid system at throughbore 158 and any component secured to surface 154 at partial bore or passage 166.

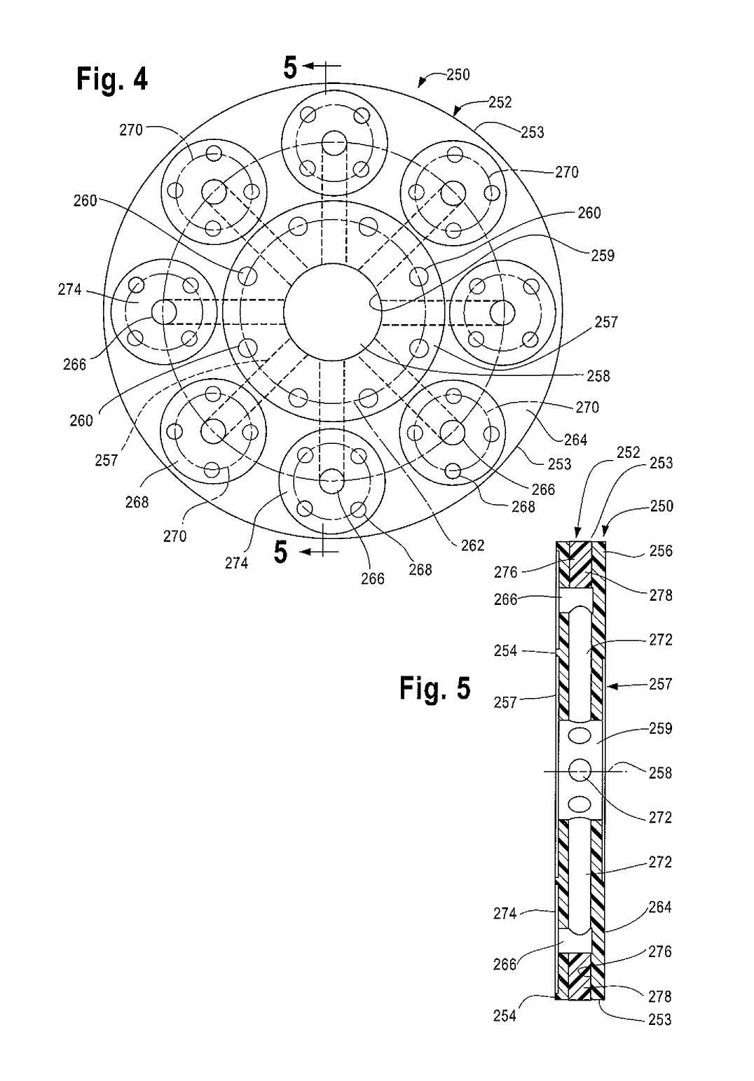

FIGS. 4 and 5 illustrate a multiple port, parallel access, piping flange 250 illustrative of the present disclosure.

The multiple port, parallel access, piping flange generally designated 250 has a planar body 252 having forward and rear faces 254 and 256. It is preferably made of UHMWPE. However, metal, lined with non-corrosive polymer is also contemplated.

Piping flange body 252 includes centrally disposed throughbore 258. The throughbore 258 is defined by a cylindrical surface 259 formed on a diameter to match the diameter of pipes of the piping system components between which it is attached. It defines the main flow passage through the multiple port, parallel access, piping flange 250.

A pattern of bolt receiving holes 260 extending through body 252 surround flow passage 258 equally spaced about a bolt circle diameter 262. The number of holes 260 and the size of the bolt circle diameter 262 is dictated by the connection flanges of the associated piping of the fluid system.

The surface of the forward face 254 and rearward face 256 surrounding the throughbore 258 define a planar annular gasket surface 257 to receive a gasket for a fluid tight connection between piping flanges as illustrated in FIG. 1 to ensure a fluid tight installation of the piping flange 250 in the piping system. As illustrated, the gasket surfaces 257 are recessed slightly into body 252 from forward and rear planar faces 254 and 256.

As best seen in FIG. 4, body 252 of multiple port, parallel access, piping flange includes an annular extension portion 264 surrounding centrally disposed throughbore 258 and pattern of bolt holes 260. As illustrated, it is integrally formed from a solid block of UHMWPE material and includes a generally cylindrical outer perimeter surface 253.

For purposes of ease in description of this embodiment, the extension portion 264 is considered as being divided into radial extension segments 265. In this illustration, eight (8) extension segments are shown, and each is substantially the same as the other. It must be appreciated any number of segments may be provided, depending on the application requirements for the piping system involved. The extension segments 265 may be integral to form an annular shape as illustrated or they may be spaced radially extending elements in a clover leaf pattern as illustrated in the embodiment of FIGS. 7 to 9.

Referring to FIG. 4, each segment includes a partial cylindrical bore or passage 266 extending from forward face 254 partially toward rear face 256. It is formed on an axis parallel to the axis of the cylindrical throughbore 258. The partial cylindrical bores 266 define access ports to the interior of the fluid system.

Each passage 266 is surrounded by a pattern of bolt holes 268 extending through body 252 and positioned on a bolt circle diameter 270. The number of bolt holes 268 and size of the bolt circle diameter 270 may vary between segments, as may the diameter of the partial bore 266, depending on the devices, fluid sources or instrumentation to be placed into communication with the main flow path of the fluid system. As in the single port parallel instrument tee 150 illustrated in FIGS. 1 to 3, the forward face 254 defines a planar annular gasket surface 274 surrounding each partial bore 266. The gasket surfaces 274 are slightly recessed from forward face 254.

Each partial bore or passage 266 represents an access port to the main fluid piping system and is connected in fluid communication with throughbore 258 by a radial fluid passage or bore 272 extending from the partial bore 266 to throughbore 258. Thus, any piping component connected to an extension segment in communication with a portal bore 266 is placed in fluid communication with the fluid piping system at throughbore 258.

As illustrated in FIG. 5, the passages 272 may be conveniently formed by drilling radial holes 276 from the outer perimeter surface 253 of body 252, to intersect partial bore or passage 266 and extend through cylindrical surface 259 into throughbore 258. Each of these radial holes defines a flow path from partial bore or passage 266 to the main flow passage of the fluid system through multiple port, parallel access piping flange 250 at throughbore 258.

The portion of each radial hole 276 extending between outer perimeter surface 253 of extension portion 264 and one of the partial bores 266 is closed by an inserted plug 278 sealed to the body within each hole 276 in fluid tight relation. For example, for a multiple port, parallel access piping flange 250 formed of UHMWPE material, a plug 278 of the same material is inserted into each radial hole 276 and connected to body 252 by spin welding or other suitable method.

In use, the flange 250 is installed in a fluid piping system as illustrated in FIG. 1 in the position of the parallel instrument tee 150. One or more flanged system components such as flanged pipes 100, flanged elbows 102 or flanged valves 104 are bolted to a segment of the extension 264, overlying one of the partial bores 266 and connected in fluid tight relation with connection bolts placed in bolt holes 268. It is contemplated that a sealing gasket be placed between the flanged component and the gasket surface 274 surrounding the associated partial bore or passage 266. The partial bore or passage 266 and fluid passage 272 provide a fluid communication path to the main flow passage at throughbore 258.

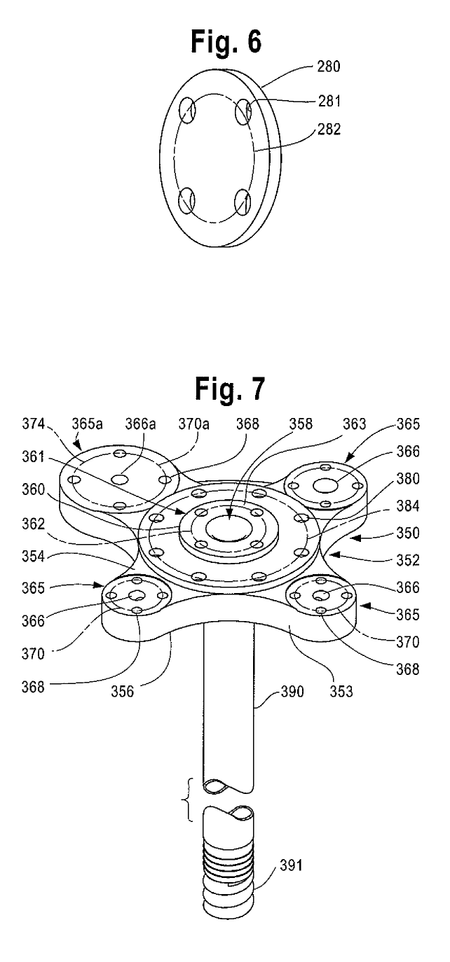

In instances where not all access ports 265 of the multiple port, parallel access, piping flange 250 are required for a given system, unused ports are closed by a cap 280 illustrated in FIG. 6. The cap includes a pattern of bolt holes 281 on a bolt circle diameter 282 that align with bolt holes 268 on bolt circle diameter 270 in extension segments 265. It is bolted onto an unused port using bolts inserted through assorted bolt holes 268. Cap 280 overlies the partial bore 266 and is secured in fluid tight relation using an interposed gasket sealed against the gasket surface 274.

The multiple port parallel access piping flange of the present disclosure is found to have advantages in applications providing plural communication paths into a containment vessel. Such an embodiment is illustrated in FIGS. 7 to 10.

Here a multiple port, parallel access, piping flange 350 is provided with a dip tube 390 which may be of a length to extend to the lower reaches of an associated containment vessel 99. Such an arrangement is useful in various fluid handling procedures including filling or removal of liquid from the tank where it is desirable to do so from adjacent the bottom of the tank. Important to such a process is the removal or introduction of air into the vessel during the liquid transfer process.

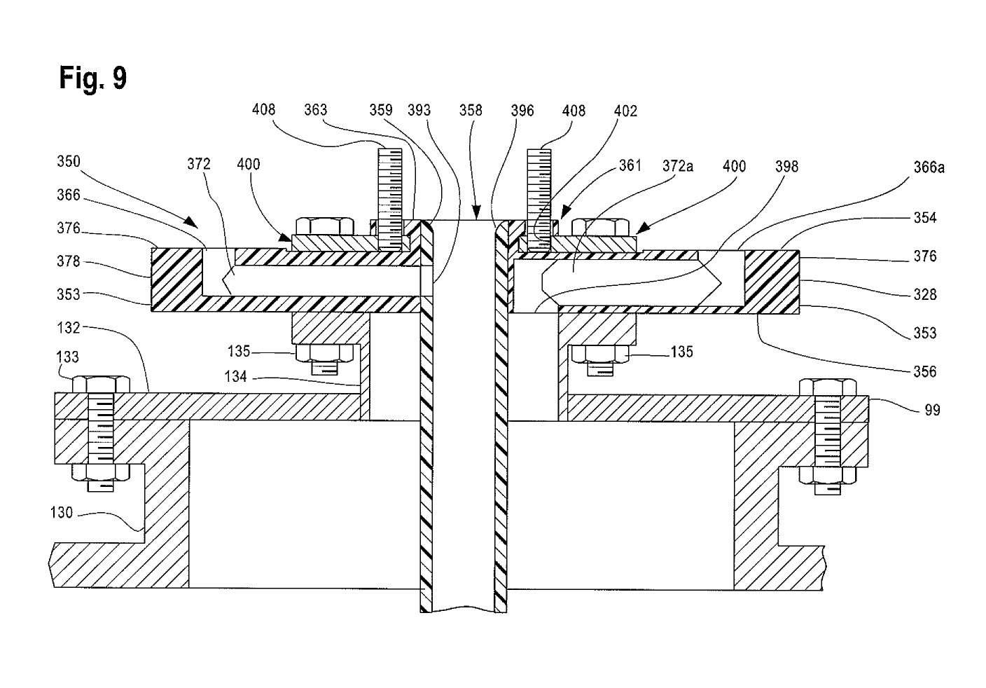

Referring to FIG. 9, there is illustrated a containment vessel or tank 99 having an upstanding flanged tubular cowling 130 defining an access port into the vessel. It has an annular bolt flange at its upper end to which is secured a circular flange plate 132 by attachment bolts 133. Flange plate 132 includes a central access port defined by a flanged tubular member 134 integrated with flange plate 132.

The multiple port, parallel access, piping flange 350 is secured to flanged tubular member 134 by attachment bolts 135. Dip tube 390 extends into the tank or vessel through the flanged tubular member 134.

FIGS. 7 to 10 illustrate a multiple port, parallel access, piping flange 350 illustrative of this embodiment of the present disclosure. It has a planar body 352 with forward and rear faces 354 and 356. It is preferably made of UHMWPE. However, metal, lined with non-corrosive polymer is also contemplated.

Piping flange body 352 includes centrally disposed throughbore 358 defined by cylindrical surface 359. A pattern of bolt holes 380 disposed on bolt circle diameter 384 surround throughbore 358. Attachment bolts 135 pass through holes 380 and secure the body 352 to the flanged tubular member 134 of tank flange plate 132. The rear face 356 defines a planar annular gasket surface 357 surrounding the throughbore 358. A gasket (not shown) is interposed between surface 357 and flanged tubular member 134 to ensure a fluid tight relationship.

Dip tube 390 includes an upper end 396 secured within the throughbore 358 defined by cylindrical surface 359 by spin welding or other suitable method to provide a fluid tight connection to body 352. In this embodiment, the interior of dip tube 390 defines the main flow passage connected to the fluid piping system. Its lower end 391 terminates adjacent the bottom of the vessel.

Body 352 includes a tubular member having an upper flange 361 which includes a pattern of holes 360 extending through the upper flange 361 surrounding throughbore 358 equally spaced about a bolt circle diameter 362. The number of holes 360 and the size of the bolt circle diameter is dictated by the connection flanges of the associated piping of the fluid system. Such piping is secured to the upper flange 361 during the performance of a filling or emptying process step. That piping, in turn, leads to associated equipment at a fluid transfer terminal.

The upper surface 363 of upper flange 361 surrounding throughbore 358 defines a planar gasket surface to receive a gasket for a fluid tight connection to the associated fluid system piping to ensure a fluid tight installation.

As best seen in FIG. 9 and for purposes explained below, body 352 includes a partial bore or passage 398 extending from rear face 356 toward forward face 354. It may be positioned adjacent, or may intersect with throughbore 358. It does not, however, extend to forward face 354.

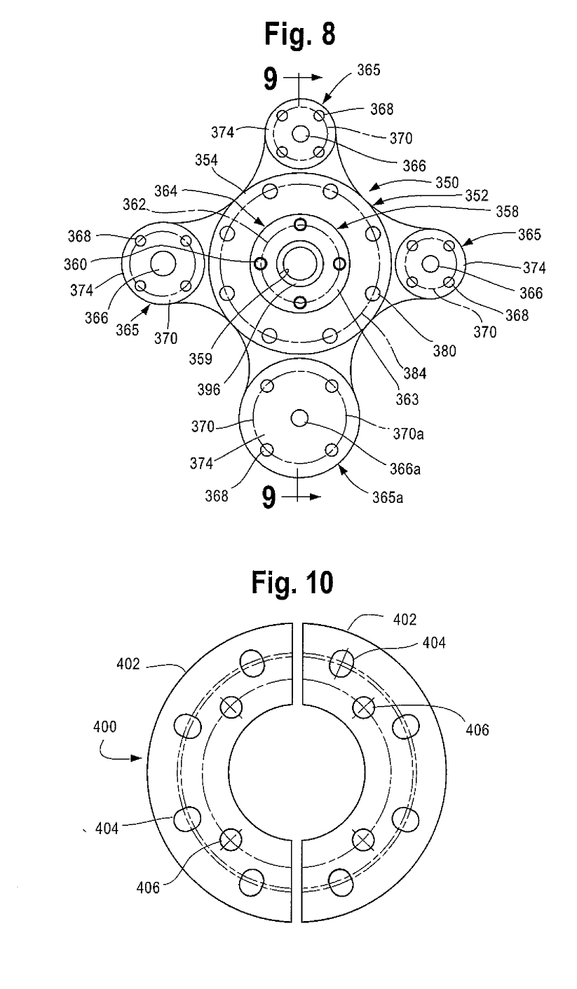

As best seen in FIGS. 7 and 8, body 352 of multiple port, parallel access, piping flange 350 includes a number of radially extending extension segments 365 arranged in a clover leaf pattern. As illustrated, the extension segments are integrally formed from a solid block of UHMWPE material and include an outer perimeter surface 353. For purposes of illustration, four extension segments 365 are shown. Each is substantially the same as the other, except as explained. It must be appreciated any number of extensions may be provided, depending on the application requirements for the piping system involved.

Referring to the drawings, extension segments 365 each include a cylindrical partial bore or passage 366 extending from forward face 354 toward rear face 356. Each is formed on an axis parallel to the axis of cylindrical surface 359 of throughbore 358. Each passage 366 is surrounded by a series of bolt holes 368 extending through body 352 and positioned on a bolt circle diameter 370. The number of bolt holes 368 and size of the bolt circle diameter 370 may vary between segments, as may the diameter of the partial bore 366, depending on the devices, fluid sources or instrumentation to be placed into communication with the fluid system associated with the multiple port parallel access piping flange 350. For example, as illustrated, extension segment 365a is larger than the other extension segments. It includes a partial bore 366a, larger in diameter than the partial bores in the other extension segments 365 and the bolt holes 368 are positioned on a larger bolt circle diameter 370a.

As in the single port parallel instrument tee 150 illustrated in FIGS. 1 to 3, the forward face 354 of body 352 defines a planar annular gasket surface 374 surrounding each partial bore 366. The gasket surfaces 374 are slightly recessed from forward face 354 of body 352.

As illustrated, partial bores or passages 366 in some of the extension segments are in fluid communication with the main flow passage of the fluid system through a fluid passage or bore 372 extending from each partial bore 366. This is not the case in connection with partial bore or passage 366a as described further below.

The passages or bores 372 are formed in the same manner as the bores 272 in the embodiment of the multiple port parallel access piping flange 250 illustrated in FIGS. 4 and 5. That is, the passage 372 of each extension segment is conveniently formed by drilling a radial hole 376 from the outer perimeter surface 353 of body 352, to intersect partial bore or passage 366 and extend through upper end 396 of dip tube 390 forming a hole 393 in the dip tube. The drilled passage thereby communicates with the main flow passage of the multiple port parallel access piping flange 350 represented by dip tube 390. Each of these radial holes defines a flow path from a partial bore or passage 366 to the interior of dip tube 390 which defines main flow passage of the fluid system through multiple port, parallel access piping flange 350 and provides access to the containment vessel 99 adjacent the bottom of the vessel.

The portion of each radial hole 376 extending between outer perimeter surface 353 and one of the partial bores 366 is closed by an inserted plug 378 sealed to the body 352 within each hole 376 in fluid tight relation as in the embodiment of FIGS. 4 and 5.

With regard to the partial bore or passage 366a, in extension segment 365a a different path is established. As best illustrated in FIG. 9, bore or passage 372a extends to the outer wall surface of dip tube 390 but does not pass through it. Instead, it communicates with partial passage 398 open through rear face 356 of flange body 352. Thus the partial bore of passage 366a and associated passage 372a is in communication with the interior of the containment vessel adjacent its top at the cowling 130. The extension segment 365a may therefore be conveniently used to attach a flanged air supply hose to permit delivery of air into the top of the vessel 99 during a liquid emptying operation where the liquid enters lower end 391 of dip tube 390 adjacent the bottom of the vessel.

In use, one or more flanged system components such as flanged pipes 100, flanged elbows 102 or flanged valves 104 are bolted to extension segments 365, each one overlying one of the partial bores 366 and connected in fluid tight relation by bolts placed in bolt holes 368. It is contemplated that a sealing gasket be placed between the flanged components and the gasket surface 374 surrounding the associated partial bore or passage 366. The partial bore or passage 366 and fluid passage 372 provide a fluid communication path to the main flow passage defined by dip tube 390 or in the instance of extension segment 365a, separately to the top of the vessel through partial bore or passage 398 in body 352.

As in the embodiment of FIGS. 4 and 5, in instances where not all access ports 366 of the multiple port parallel access piping flange 350 are required for a given system, unused ports are closed by a cap 280 illustrated in FIG. 6. Cap 280 is bolted onto an extension segment 365 overlying a given partial bore 366 using bolts inserted through bolt holes 368. Cap 280 overlies the partial bore or passage 366 and is secured in fluid tight relation with an interposed gasket sealed against the gasket surface 374 surrounding partial bore or passage 366. As best seen in FIGS. 9 and 10, this embodiment of the multiple port, parallel access, piping flange 350 utilizes an arrangement for mounting to a containment vessel and for attaching it to the fluid system similar to that disclosed in application for U.S. patent Ser. No. 12/755,960 filed Apr. 7, 2010, entitled “Eduction Tube Assembly,” the entire specification and drawings of which are incorporated by reference herein. The arrangement includes segmented metal ring 400 for securement of the flange 350 to the containment vessel and for connection of an associated flanged connector from the fluid system to the upper flange 361 of body 352 in fluid tight relation.

The segmented ring 400 seen in FIGS. 9 and 10 is an annular ring split along a diametrical line to form two separate ring segments 402. These segments have planar top and bottom faces and are of a thickness to fit between the forward face 354 of body 352 and the underside of upper flange 361.

The segments include holes 404 aligned with bolt holes 380 in body 352 to permit passage of bolts 135 to secure the multiple port, parallel access, piping flange 350 to flanged tubular member 134 of tank flange plate 132.

The segments 402 of ring 400 also include threaded holes 406 aligned with holes 360 in upper flange 361. These threaded holes 404 retain threaded studs 408 that extend upward through holes 360 and are used for securement of flanged connectors from an associated fluid system to the multiple port parallel access flange 350 at upper flange 361 of body 352 in fluid tight relation.

The segmented ring 400 provides rigid support for the bolts 135 connecting the multiple port parallel access flange to the vessel 99 and the studs 408 connecting the upper flange 361 of body 352 to the associated system piping. Because the ring 400 comprises split segments 402, these segments are easily slid into position axially prior to installation of studs 408 through holes 360 in upper flange 361.

Various features of the present invention have been described with reference to the above illustrative embodiments. It should be understood that modifications may be made without departing from the scope of the invention as represented by the following claims.

1. A multiple port, parallel access, piping flange including:
a body having a forward face and a rear face and a cylindrical surface defining a throughbore extending through said body;
a radial extension portion defining a plurality of extension segments extending from said body;
each said extension segment including a partial bore extending from said forward face toward said rear face;
and a radial passage formed in each said extension segment in communication with said partial bore thereof, said radial passages in at least some of said extension segments communicating with said throughbore.

2. A multiple port, parallel access, piping flange as claimed in claim 1 wherein said forward face and said rear face define a planar annular gasket surface surrounding said throughbore.

3. A multiple port, parallel access, piping flange as claimed in claim 2 wherein each said extension segment includes a planar annular gasket surface surrounding said partial bore.

4. A multiple port, parallel access, piping flange as claimed in claim 3 wherein said body includes a series of bolt holes on a bolt circle diameter surrounding said throughbore and each said extension segment includes a series of bolt holes on a bolt circle diameter surrounding said partial bore in said extension segment.

5. A multiple port, parallel access, piping flange as claimed in claim 3 wherein said throughbore defined by said cylindrical surface has an axis and said partial bore in each said extension segment is formed by a cylindrical bore having an axis parallel to the axis of said cylindrical surface of said throughbore.

6. A multiple port, parallel access, piping flange as claimed in claim 1 wherein said partial bore in at least one of said extension segments is larger than the partial bore in another of said extension segments.

7. A multiple port, parallel access, piping flange as claimed in claim 1 including a tubular member secured within said cylindrical surface in fluid tight relation to said body and radial passages of at least some of said extension segments extend through said tubular member.

8. A multiple port parallel access piping flange as claimed in claim 7 wherein said body includes a partial bore separate from said throughbore extending from said rear face toward said forward face and said radial passage in at least one of said extension segments in communication with said partial bore extending from said rear face.

9. A multiple port, parallel access, piping flange as claimed in claim 7 wherein said body includes an upper flange spaced from said forward face surrounding said throughbore and includes a series of holes on a bolt circle diameter, and said upper flange defines a planar annular gasket surface surrounding said throughbore,
a segmented ring comprising semi-circular annular segments between said forward face and said upper flange having threaded holes aligned with said holes in said upper flange and threaded studs secured to said segmented ring and extending through said holes in said upper flange.

10. A multiple port, parallel access, piping flange as claimed in claim 9 wherein said body includes a series of bolt holes on a bolt circle diameter surrounding said throughbore and said segmented ring includes a series of holes aligned with said bolt holes in said body.

11. A multiple port, parallel access, piping flange as claimed in claim 10 wherein said partial bore in at least one of said extension segments is larger than the partial bore in another of said extension segments.

12. A multiple port, parallel access, piping flange as claimed in claim 8 wherein said partial bore in at least one of said extension segments is larger than the partial bore in another of said extension segments.

13. A multiple port, parallel access, piping flange as claimed in claim 8 wherein said body includes an upper flange spaced from said forward face surrounding said throughbore and includes a series of holes on a bolt circle diameter, and said upper flange defines a planar annular gasket surface surrounding said throughbore,
a segmented ring comprising semi-circular annular segments between said forward face and said upper flange having threaded holes aligned with said holes in said upper flange and threaded studs secured to said segmented ring and extending through said holes in said upper flange.

14. A multiple port, parallel access, piping flange as claimed in claim 13 wherein said body includes a series of bolt holes on a bolt circle diameter surrounding said throughbore and said segmented ring includes a series of holes aligned with said bolt holes in said body.

15. A multiple port, parallel access, piping flange as claimed in claim 14 wherein said partial bore in at least one of said extension segments is larger than the partial bore in another of said extension segments.

16. A multiple port, parallel access, piping flange as claimed in claim 1 wherein each said radial passage of each said extension segment communicates with said throughbore.

17. A multiple port, parallel access, piping flange as claimed in claim 16 wherein said forward face and said rear face define a planar annular gasket surface surrounding said throughbore.

18. A multiple port, parallel access, piping flange as claimed in claim 17 wherein each said extension segment includes a planar annular gasket surface surrounding said partial bore.

19. A multiple port, parallel access, piping flange as claimed in claim 18 wherein said body includes a series of bolt holes on a bolt circle diameter surrounding said throughbore and each said extension segment includes a series of bolt holes on a bolt circle diameter surrounding said partial bore in said extension segment.

20. A multiple port, parallel access, piping flange as claimed in claim 19 wherein said throughbore defined by said cylindrical surface has an axis and said partial bore in each said extension segment is formed by a cylindrical bore having an axis parallel to the axis of said cylindrical surface of said throughbore.
